(19) United States
(12) Patent Application Publication
(10) Pub. No.: US 2007/0067170 A1
(43) Pub. Date: Mar. 22, 2007

(54) Method for identifying people

(76) Inventor: Markus Kress, Mannheim (DE)

Correspondence Address: FRIEDRICH KUEFFNER, 317 MADISON AVENUE, SUITE 910, NEW YORK, NY, 10017, US

(21) Appl. No.: 10/585,044

(22) PCT Filed: Dec. 29, 2004
(86) PCT No.: PCT/EP04/14799

§ 371 Date: Jun. 29, 2006

(30) Foreign Application Priority Data
Dec. 31, 2003 (DE) 103 61 850.3

(51) Int. Cl. G10L 15/00

(52) U.S. Cl. 704/249

(57) ABSTRACT

The invention relates to a method for identifying people, whereby a person is identified by comparing an electric signal derived from a sound produced by the person with a stored signal of the above kind. The invention is characterized in that the signals to be compared are derived from the subphonenic range of sound production. The signal especially refers to a quasiperiod of a vowel or a semivowel.

The invention relates to a method for identifying people, in which a person is identified by comparing an electrical signal derived from a particular utterance by the person with a stored signal of this kind.

Methods of this kind for identifying people from their voice which are known from EP 0 896 711 B1 and DE 100 42 571 C2 use a signal for comparison which corresponds to the entire utterance or to a succession of sounds which is selected therefrom. Individual features contained in these signals permit more or less certain identification of people.

Depending on the number of comparison signals stored, i.e. depending on the size of the group of people from which individual people are intended to be identified, an identification process based on a method of this kind may be relatively laborious and the method may be unsuitable for checking access authorization for a relatively large business or for a relatively large institution, for example.

The invention is based on the object of providing a new method of the type mentioned at the outset which allows faster identification of people with a higher certainty of identification than the known methods of this kind.

The inventive method achieving this object is characterized in that the signals to be compared are derived from a subphonemic range of the utterance.

The invention is based on the insight that a signal which is derived from A short, as such inaudible, excerpt from the utterance or from an electrical total signal corresponding thereto already has a sufficient number of features which are characteristic of an individual in order to be able to make an identification. Advantageously, the brevity of the signal means that the extent of the data to be processed in an identification process is far less than that in the known methods, which significantly shortens the identification process. In addition, the individual features are more prominent in the shorter comparison signal, whereas they are more “blurred” in an electrical signal corresponding to a longer succession of sounds. Consequently, the invention also increases the certainty of identification. Incorrect statements about a match or mismatch between comparison signals are almost precluded.

Preferably, in a first step for deriving the signals to be compared, an electrical output signal from an electroacoustic transducer, which output signal corresponds to the entire utterance, is subjected to volume normalization. This advantageously filters out signal differences which are not based on any kind of individual character. The volume normalization can take place actually in a microphone appliance unit which can be connected to a computer with a microphone input.

The computer digitizes the output signal and expediently forms a Fourier series which approximates the output signal and which can be taken as a basis for the further signal processing in the computer.

In one preferred embodiment of the invention, a quasi-periodic range of the signal is ascertained in the digitized output signal from the electroacoustic transducer, which output signal corresponds to the utterance. A quasi-periodic range is present whenever the utterance contains a vowel or semivowel.

Whereas it is possible to select any subphonemic subrange, from the quasi-periodic range, e.g. corresponding to the letter a, the preferred embodiment of the invention involves just a single quasi-period being respectively selected in order to form a comparison signal or in order to form a plurality of comparison signals.

This expediently involves a particular quasi-period n from the quasi-periodic range 1 to m. Nonindividual signal characters which are based merely on different positions of the comparison period within the quasi-periodic range are filtered out in this manner.

In a further advantageous refinement of the invention, the selected quasi-period is subjected to length normalization, i.e. is expanded or compressed to a standard length T. Fluctuations in the period length within the quasi-periodicity and, in particular, pitch-dependent period length differences are compensated for in this way and individual characters of the signal are associated more accurately with particular times within the period T. They therefore occur more accurately in comparison.

In a further refinement of the invention, a quotient signal is formed as comparison signal from the selected quasi-period and from a quasi-period of this kind which is averaged over a multiplicity of people.

A quotient signal of this kind is thus referenced to a signal which has only little individual character. Accordingly, individual characters occur all the more in the quotient signal.

In addition, the preferred embodiment of the invention involves a plurality of, e.g. three, comparison signals which are to be stored being formed by recording and processing the utterance at different pitches. The identification involves interpolation being performed or a family of curves for stored comparison signals is formed by interpolation.

The identification method may be part of a voice recognition program, or the comparison signals may be blocks in a synthesis program for speech.

The invention will now be explained in more detail with reference to an exemplary embodiment and to the accompanying drawings which relate to this exemplary embodiment and in which:

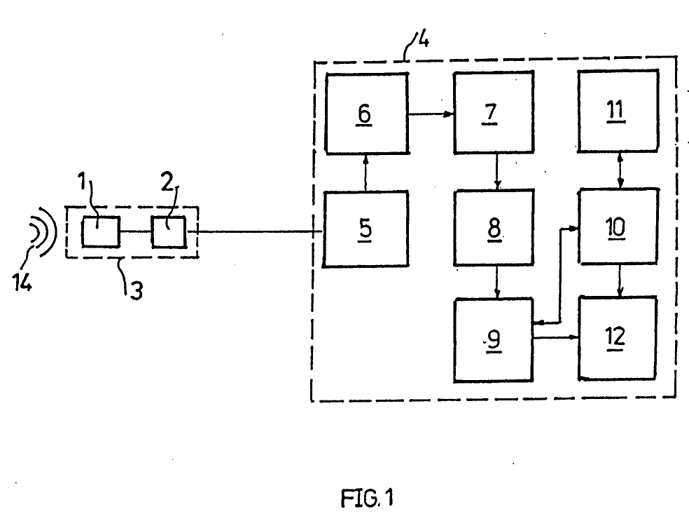

FIG. 1 shows a schematic illustration of an identification apparatus operating on the basis of the inventive method, and

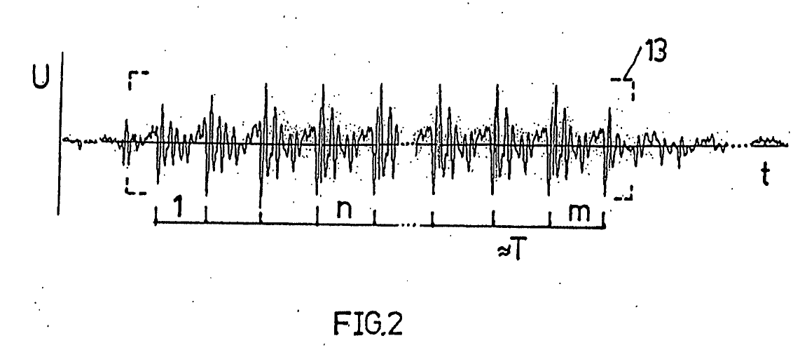

FIG. 2 shows an electrical signal which corresponds to an utterance and from which it is possible to derive a comparison signal based on the invention which is suitable for identifying people.

In FIG. 1, the reference symbol 1 refers to an electroacoustic transducer which has a downstream device 2 which performs volume normalization. The electroacoustic transducer 1 and the normalization device 2 are combined to form an appliance unit 3 which is connected to a microphone input of a computer 4.

The computer 4 contains devices 5 to 12 which are formed by hardware and software.

A digitization device 5 receives the output signal from the appliance unit 3. The signal digitized by the device 5 is passed to a device 6, in which a Fourier series approximating the signal is formed and is taken as a basis for the further signal processing.

A device 7 ascertains a quasi-periodic range of the signal from which a downstream device 8 selects at least one particular quasi-period. It is also possible to select quasi-periods from a plurality of ascertained quasi-periodic ranges.

A downstream device 9 processes the selected quasi-period, e.g. expands or compresses it in time to a standard length.

Depending on whether a comparison signal is intended to be stored or a person is intended to be identified, the processed quasi-period is supplied as comparison signal to a memory device 10 or to a comparator device 12.

The comparator device 12 compares the processed quasi-period with stored signals of this kind for a multiplicity of people and identifies a person by establishing a match with one of the stored signals.

An averaging device 14 forms an averaged signal from the signals stored for the multiplicity of people, and said signal can be stored in the memory device 10 and supplied to the processing device 9.

An identification process is explained in more detail below with reference to FIG. 2.

A person to be identified for whom a comparison signal is stored in the memory device 10 speaks a prescribed word, for example the word “mama”. From a corresponding audio signal 14, the appliance unit 3 forms a normalized-volume signal U (t). A portion of this signal which relates to the first vowel “a” in the word “mama” is shown in FIG. 2.

The total normalized-volume signal U (t) corresponding to the word “mama” is digitized by the device 5, and the function U (t) is then represented by a Fourier series in the device 6. Further signal processing operations are performed on the basis of this Fourier series.

In the next processing step, the device 7 uses a time-variable observation window 13 in the total signal U (t) to ascertain a first quasi-periodic range containing quasi-periods 1 to m and selects at least one quasi-period n from the range.

Since the length of the quasi-periods fluctuates somewhat and is additionally dependent on the respective pitch, the processing device 9 expands or compresses the selected period n to a standard length T. In addition, the device 9 forms a quotient signal from the expanded or compressed period n and from a signal which has been generated by the device 11 and which is stored in the memory device 10. This signal is an average of the signals for a multiplicity of people. This quotient signal contains outstanding individual peculiarities. Beyond this quotient signal, it is also possible to form a quotient using a comparison signal which has been recorded under particular emotional conditions.

If a sample is being taken from a person who is to be recorded in the group of people who are to be identified, the comparison signal processed by the processing device 9 is stored in the device 10, with such sample-taking involving a plurality of, e.g. three, comparison signals being formed, namely for three different pitches in which the word “mama” can be spoken. In the case of identification, the signal in question is supplied to the comparator device 12, which performs a comparison with all the comparison signals stored in the device 10. If a match with one of the stored signals is found, the person is identified as being associated with the group of people.

1. A method for identifying people, in which a person is identified by comparing an electrical signal derived from a particular utterance by the person with a stored signal of this kind,
wherein the signals to be compared are derived from a subphonemic range of the utterance.

2. The method as claimed in claim 1, wherein in a first step for deriving the signals an electrical output signal from an electro-acoustic transducer (1), which output signal corresponds to the entire utterance, is subjected to volume normalization.

3. The method as claimed in claim 1, wherein a Fourier series approximating an output signal corresponding to the entire utterance is formed.

4. The method as claimed in claim 2, wherein to derive the signals which are to be compared at least one quasi-periodic range of the output signal is ascertained.

5. The method as claimed in claim 4, wherein to derive the signals which are to be compared a single quasi-period or a plurality of quasi-periods is/are selected from the ascertained quasi-periodic range.

6. The method as claimed in claim 5, wherein a quasi-period (n) determined in relation to its position in the quasi-periodic range (1 to m) is selected.

7. The method as claimed in claim 5, wherein the selected quasi-period is subjected to length normalization.

8. The method as claimed in claim 5, wherein a quotient signal is formed from the selected quasi-period and from a quasi-period which is influential an an average voice.

9. The method as claimed in claim 1, wherein to form comparison signals which are to be stored the utterance is recorded a plurality of times at different pitches and, during identification, is interpolated between plurality of comparison signals, or interpolation is used to form a family of curves for comparison signals.

10. The method as claimed in claim 1, wherein the method is integrated into a voice recognition program.

11. The method as claimed in claim 1, wherein the signals to be compared are used as blocks in a voice synthesis program.
